(19) United States
(12) Patent Application Publication
(10) Pub. No.: US 2013/0179204 A1
(43) Pub. Date: Jul. 11, 2013

(54) METHOD, SYSTEM AND DEVICE FOR A GEOLOCATIONAL TRACKING AND MANAGEMENT OF AGRICULTURAL WORKFLOW

(71) Applicant: Antonio Sabarez, II, Monterey, CA (US)

(72) Inventor: Antonio Sabarez, II, Monterey, CA (US)

(21) Appl. No.: 13/347,702

(22) Filed: Jan. 11, 2012

(51) Int. Cl. G06Q 10/00

(52) U.S. Cl. 705/7.11

(57) ABSTRACT

Methods, systems and devices for enabling the geolocational monitoring, tracking and management of an agricultural workflow are provided. A first version of the method includes defining a unique area of plant cultivation or animal husbandry; recording inputs to the area with a GPS device; reporting the inputs and related GPS confirmations to a database in association with the area; recording outputs from the area with the GPS device 2; and reporting the outputs and related GPS confirmations to a database in association with the area, whereby a net yield of the area over time can be appraised in view of the inputs and outputs of the area. A marker may be assigned to a element of crop or animal output and the element may be monitored by references to the marker over distance and time.

### FIELD OF THE INVENTION

The present invention relates generally to methods and systems of agricultural process monitoring and management, and more particularly to associating aspects and elements of agricultural production, processing and delivery with distinguishable persons, goods and locales.

### BACKGROUND OF THE INVENTION

Many environments within the agricultural sector have proven to be resistant to harvesting the benefits of information technology than most industrial and manufacturing operations. In many aspects of prior art agricultural production and foodstuff management, the logging and association of agricultural inputs and relevant production factors, e.g., seed, fertilizer, pesticides, plant nutrients, and labor, with specific food items, locations and fields of plant growth, individual farm workers, shipping and processing agents, and the stream of agricultural commerce have not been optimally addressed or enabled by the prior art.

Escalating concerns over food safety and immigrant worker tracking in the first decade of this century have significantly increased in importance in the consciousness of the public and numerous United States government agencies and officials. In particular, the importance of control, tracking and documenting of the persons and phases through which an individual foodstuff has contact, or may be affected by, has increased in public and governmental priority in the last ten years. As a consequence of these concerns, many government agencies are expanding their vigilance over, and legally enforceable duties of, vendors and firms in the food industry.

The standard commercial processes of agricultural outputs thus increasingly present many situations wherein the assignment of responsibility of protection, care and management of an agricultural product may affect a determination of a criminal or civil penalty or an attribution of a cost liability. As one example, when a shipment of foodstuffs is determined to have aged in transit and thereby decreased in value, determining liability for this value reduction can be difficult to objectively assign. As another example, a failure to document and report the attendance or absence of certain categories of immigrant workers to a government agency may result in a financial penalty and a criminal citation.

In another aspect of the prior art, failure to distinguish associate a particular agricultural product, e.g., an individual piece of fruit, or a lot of foodstuff, with a plot of land where the food was originated to a degree of specificity that enables an analyst to apply tools and methods to optimally increase cost efficiency and maximally improve management of a delineated plant growth plot.

There is therefore a long felt need to provide systems and methods that improve the application of information technology and geolocational tracking and monitoring to agricultural and food management processes.

### OBJECTS OF THE INVENTION

It is an object of the method of the present invention to enhance food safety.

It is another object of the method of the present invention to provide improved devices, systems and methods that enable the monitoring and analysis of aspects, conditions and outcomes of an agricultural production process.

It is another object of the method of the present invention to increase accountability of agricultural workers by enabling the tracking of individual workers with reference identifiers that are recorded in association with time, date and location information.

### SUMMARY OF THE INVENTION

These and other objects of the present invention are made obvious in light of this disclosure, wherein methods, systems and computer-readable media for monitoring and managing agricultural production process. According to a first aspect of the method of the present invention, a method is provided that applies information technology to monitor the materiel inputs, or “area inputs”, to a location where a crop is managed or grown. These area inputs may include seeds, plants, plant cuttings, animals, insects, water, organic and inorganic chemicals, fertilizers, pesticides, pest reduction agents, plant growth enhancement agents, plant nutritional agents, a plant disease inhibition agents, equipment, and laborers.

According to a second optional aspect of the method of the present invention, a plant growth location is delineated and assigned a geolocational identifier. Geolocational signal equipment may be provided, for example hand-held electronic global information system receivers, that are used to both log data related to the growth location and confirm and document that the data is being logged into a global information system receiver while the information system receiver is located within or proximate to the plant growth location. The logged data may include date/time stamping, identifiers of types of area inputs, descriptions of conditions and amounts of area inputs, and information related to the agricultural products generated at the plant growth location. It is understood that the term “agricultural product” is defined with a range of meaning that includes plant, vegetable, fruit and animal entities and elements thereof.

According to a third optional aspect of the method of the present invention, a worker identifier may be assigned to one or more human beings, wherein the identifier may be communicated to the geolocational signal equipment by manual data input, by radio frequency transmission, by bar code detection, by face recognition module, or by manual data input. A record of the date, time and location of the receipt of a worker identifier may be recorded by the geolocational signal equipment and communicated by physical transfer of electronic media or via an electronic communications network, such as a telephony network, a radio communications network or the Internet, in isolation or in combination.

According another aspect of the invention, a hand held device is provided that accepts and records geolocational signals transmitted through a global position system (hereinafter, “GPS”).

According a still other optional aspect of the invention, a global information system (hereinafter, “GIS”) is provided that accepts and records GPS data and correlates GPS data with information associated with area inputs, crop or animal outputs, conditions and aspects of one or more delineated areas of plant cultivation or animal management.

According yet another optional aspect of the invention, an element of crop cultivation is instantiated at or proximate to an identified area of plant cultivation, assigned an element identifier, or “marker”, and then tracked by referenced to the element marker as the element passes along the stream of commerce from the area of plant cultivation and to the consumer or end user.

### INCORPORATION BY REFERENCE

All publications mentioned herein are incorporated herein by reference to disclose and describe the methods and/or materials in connection with which the publications are cited. All publications, patents, and patent applications mentioned in this specification are herein incorporated by reference in their entirety and for all purposes to the same extent as if each individual publication, patent, or patent application was specifically and individually indicated to be incorporated by reference.

U.S. Pat. No. 8,037,846 (inventor: Pratt and issued on Oct. 18, 2011) titled “Method and system for tracking and managing animals and/or food products”; U.S. Pat. No. 7,904,373 (inventors: Kimle, et al. and issued on Mar. 8, 2011) titled “Method for electronically initiating and managing agricultural production contracts”; U.S. Pat. No. 7,772,983 (inventors: Grose, et al. and issued on Aug. 10, 2010) titled “Apparatus for tracking carcass”; U.S. Pat. No. 7,702,462 (inventors: Fuessley, et al. and issued on Apr. 20, 2010) titled “Method and apparatus for tracking individual plants while growing and/or after harvest”; U.S. Pat. No. 6,745,127 (inventor: Crosby and issued on Jun. 1, 2004) titled “System and method for tracking and reporting pesticide and fertilizer use on agricultural products”; and U.S. Pat. No. 6,554,188

(inventors: Johnson, et al. and issued on Apr. 29, 2003) titled “Terminal for an active labeling system”.

The publications discussed or mentioned herein are provided solely for their disclosure prior to the filing date of the present application. Nothing herein is to be construed as an admission that the present invention is not entitled to antedate such publication by virtue of prior invention. Furthermore, the dates of publication provided herein may differ from the actual publication dates which may need to be independently confirmed.

### BRIEF DESCRIPTION OF THE FIGURES

These, and further features of various aspects of the present invention, may be better understood with reference to the accompanying specification, wherein:

FIG. 1 is an illustration of a crop cultivation area A located within a larger geographic area;

FIG. 2 is a schematic of the GPS device of FIG. 1;

FIG. 3 is a schematic of an electronics communications network comprising the Internet, the GPS device of FIGS. 1 and 2, a GIS, and a database server;

FIG. 4 is an illustration of a first area data set record that may be stored in the GPS device of FIGS. 1, 2 and 3, the GIS and the database server of FIG. 3, includes data relating the area of FIG. 1 to a crop area, a GPS location, a worker identifier, a plurality of area inputs to the area A, and/or historical data;

FIG. 5 is process diagram of certain aspects of the method of the present invention as enabled by the GPS device of FIGS. 1, 2 and 3 and the electronics communications network of FIG. 2;

FIG. 6 is a flowchart of certain other aspects of the method of the present invention related to monitoring a distinguishable crop growing area that may be implemented by the GPS device of FIGS. 1, 2 and 3 and the electronics communications network of FIG. 3;

FIG. 7 is an illustration of an exemplary first crop element record that includes a crop area identifier rand information related to the crop area and crop element of FIG. 1;

FIG. 8 is a schematic of an RFID device containing a crop element record of FIG. 7, a worker record and/or a crop area record;

FIG. 9 is an illustration of an exemplary first worker record that includes a worker identifier rand information related to the worker and crop area(s) and crop element(s) of FIGS. 1, 4 and 7; and

FIG. 10 is an illustration of a database of FIG. 2 that may be stored in a device, computer or server of FIG. 1, 2, or 3 and comprising information partially or entirely of FIGS. 2, 4 and 7.

### DETAILED DESCRIPTION

It is to be understood that this invention is not limited to particular aspects of the present invention described, as such may, of course, vary. It is also to be understood that the terminology used herein is for the purpose of describing particular aspects only, and is not intended to be limiting, since the scope of the present invention will be limited only by the appended claims.

Methods recited herein may be carried out in any order of the recited events which is logically possible, as well as the recited order of events.

Where of values is provided herein, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the methods and materials are now described.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

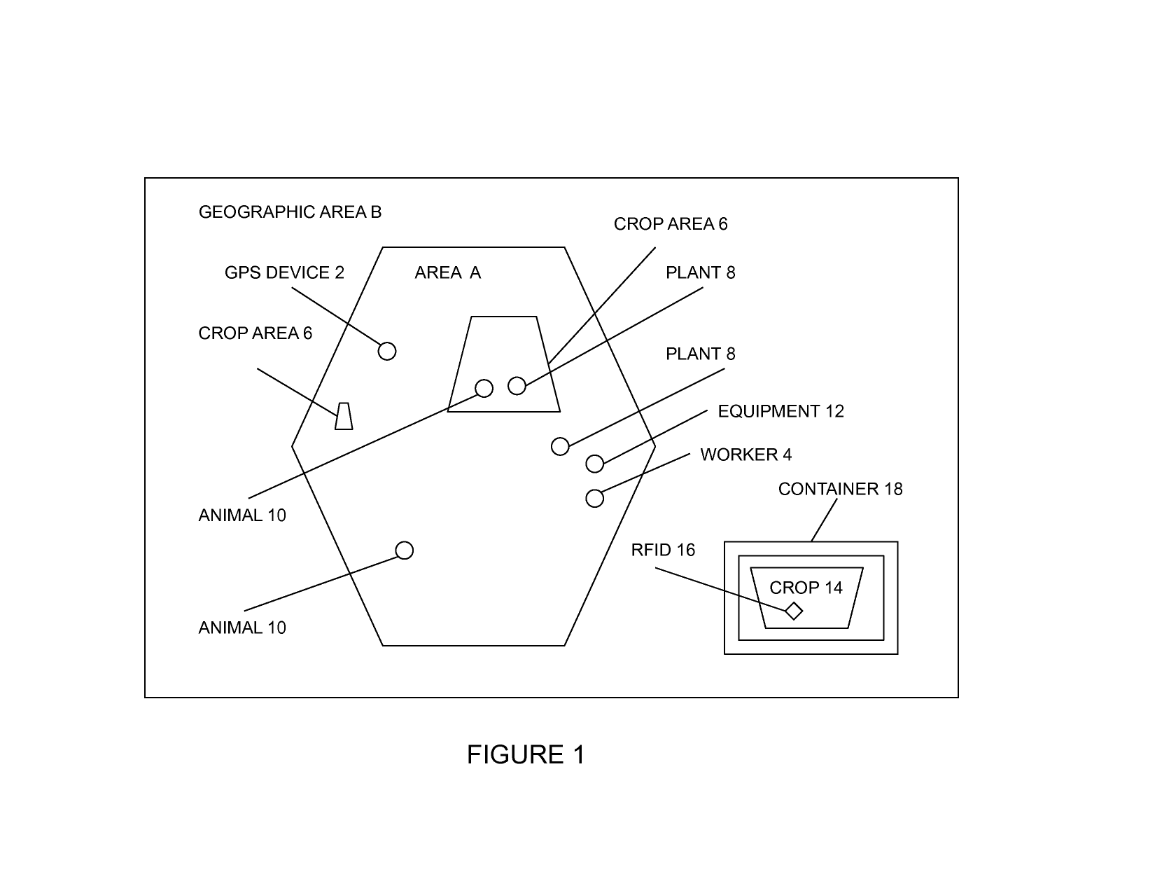

Referring now generally to the Figures and particularly to FIG. 1, FIG. 1 is an illustration of a crop cultivation area A located within a larger geographic area B. A GPS device 2 is placed within an area A wherein a human worker 4, a defined crop growth area 6 (hereinafter, “crop area” 6), a plurality of plants 8, a plurality of animals 10, and a mobile farm equipment 12, such as a tractor or a plant bagger, are located. The GPS device 2 accepts and records information, including but not limited to information identifying or describing a quality, aspect or element related or provided regarding the area A, one or more crop areas 6, equipment 12, and life forms 4, 8 & 10 located within the area A. The recorded information is associated with a GPS signal received by the GPS device 2 and optionally (a.) a crop area identifier CE.ID; (b.) information related to or identifying a crop area 6, the Area A, a worker 4, an equipment 12, and/or a plant 8, and/or (c.) a time date stamp 14B.

An exemplary crop 14 comprises an agricultural output, e.g., plants, fruits, vegetables, meat sections, livestock, and/or other suitable agricultural process outputs known in the art, that has been harvested from, collected at, or removed from a distinguishable and identified crop area 6. An RFID marker device 16 travels with the crop element 14 (or “crop” 14″) in the stream of commerce optionally with or within a crop container 18. The crop 14 may be or comprise, for example but not limited to, an individual animal, tree or plant, or a plurality, bushel, or container load of fruit, vegetables, livestock or other suitable agricultural process output known in the art. The crop container 18 segregates the crop 14 and supports the identification of the crop 14 as the crop 14 is transported and processed through the stream of commerce extending from the originating and identified crop area 6 and to the consumer, and optionally beyond delivery to the consumer and in one or more stages of recycling, composting, and/or waste management. The RFID marker 16 may this send and receive information to and from the communications network 20, the Internet 22, the telephony network 30, one or more GPS devices 2, GIS servers 24, database servers 26, network computers 28, and RFID writers/readers 32 to generate and store information related to the instant crop 14 as the crop 14 is moved through the stream of commerce.

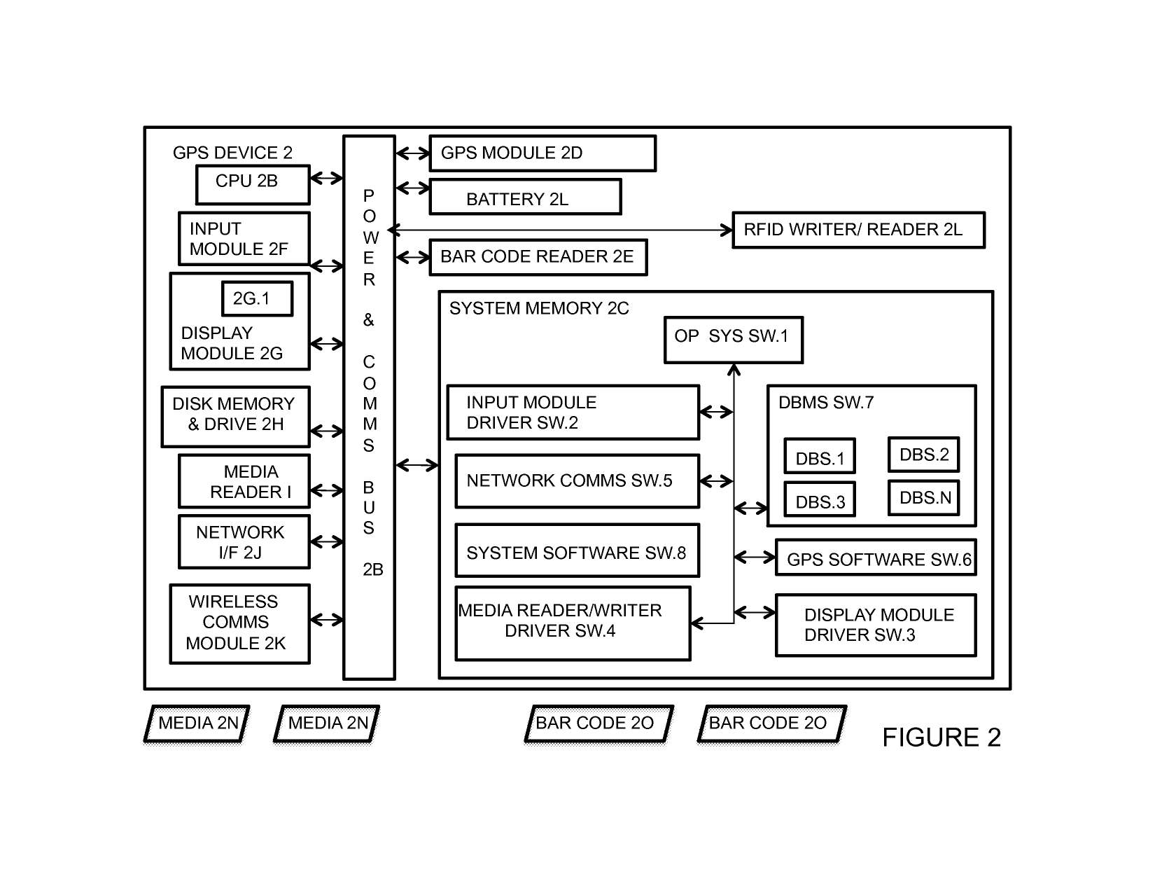

Referring now generally to the Figures and particularly to FIG. 2, FIG. 2 is a schematic of the GPS device 2 of FIG. 1. An internal power and communications bus 2A bi-directionally communicatively couples a central processing unit 2B (“CPU” 2B), a system memory 2C, a GPS module 2D, a visual pattern bar code reader 2E, a data input module 2F, a display module 2G having a display screen 2G1, a disk memory, controller and disk memory module 2H, an electronic media reader 2I, a network interface module 2J, a wireless communications module 2K, and an RFID writer/reader. A battery 2M is further coupled with the GPS device 2 elements 2A-2K by means of the power and communications bus 2A and provides electrical power to the elements 2A-2K of the GPS device 2. The electronic media reader 2I and each of a plurality of electronic media 2N are selected are configured to enable the transfer of software encoded data and instructions between the GPS device 2 and the electronic media 2N.

The bar code reader 2E and each of a plurality of bar code patterns 2O are selected are configured to enable the transfer of encoded identifiers, data and instructions as encoded in the bar code pattern and the electronic media 2N. One or more identifiers, data and instructions of one or more of the bar code patterns may identify and/or relate to one or more human workers 4, crop areas 6, plants 8, animals 10, equipment 12, and/or crops 14. Alternatively or additionally, one or more identifiers, data and instructions of one or more of the bar code patterns 2O may identify and/or relate to an identification of a plant seed, an identification of a plant fertilizing agent, an identification of a plant nutritional agent, an identification of a volume of water, an identification of a pest reduction agent, an identification of a plant disease, and/or other data related to, describing or identifying an agricultural process input. Still alternatively or additionally, one or more identifiers, data and instructions of one or more of the bar code patterns 2O may identify and/or relate to an agricultural process output, such as a fruit or vegetable, a measure of a harvested plant element, an animal or animal product, and/or other agricultural process output known in the art.

The RFID reader/writer 2L and the RFID marker 16 are selected and configured to communicate, store and/or exchange information relating to the Area A, the associated crop 14, the instant crop area 6, an identification of a plant seed, an identification of a plant fertilizing agent, an identification of a plant nutritional agent, an identification of a volume of water, an identification of a pest reduction agent, an identification of a plant disease, and/or other data related to, describing or identifying an agricultural process input. Still alternatively or additionally, information communicated between the RFID marker 16 and the RFID reader/writer 2L may identify and/or relate to an agricultural process output comprised within the crop 14 associated with the RFID marker 16, such as a fruit or vegetable, a measure of a harvested plant element, an animal or animal product, and/or other agricultural process output known in the art.

The GPS device 2 system memory 2C has various software programs and utilities stored therein, to include, but not limited to, an operating system SW.1, an input module driver software SW.2, a display module driver software SW.3, a media reader module driver software SW.4, a network communications software SW.5, a GPS software SW.6, a database management software SW.7 (hereinafter “DBMS” SW.7) and a system software SW.8. The DBMS SW.7 includes a plurality of software databases DBS.1, DBS.2, DBS.3 & DBS.N.

The operating system software SW.1 may be selected from freely available, open source and/or commercially available operating system software, to include but not limited to a LINUX™ or UNIX™ or derivative operating system, such as the DEBIAN™ operating system software as provided by Software in the Public Interest, Inc. of Indianapolis, Ind.; a WINDOWS XP™, VISTA™ or WINDOWS 7™ operating system as marketed by Microsoft Corporation of Redmond, Wash.; or the MAC OS X operating system or iPhone G4 OS™ as marketed by Apple, Inc. of Cupertino, Calif.

The database management system DBMS SW.7 may be or comprise an object oriented database management system (“OODBMS”) and/or a relational database management system (“RDBMS”), and one or more databases DBS.1-DBS.N may be or comprise an object oriented database and/or a relational database. The DBMS SW.7 may be selected from prior art database management systems including, but not limited to, Objectivity/DB 10™ marketed by Objectivity, Inc. of Mountain View, Calif.; a Database 2™, also known as DB2™, relational database management system as marketed by IBM Corporation of Armonk, N.Y.; and the Advantage Database Server™ relational database management system.

The GPS device 2 may be or comprise (a.) an IPHONE G4™ internet enabled cellular telephone marketed by Apple, Inc., of Cupertino, Calif.; (b.) an IPAD™ tablet computer marketed by Apple, Inc., of Cupertino, Calif.; (c.) or other suitable or handheld portable computational communications device known in the art.

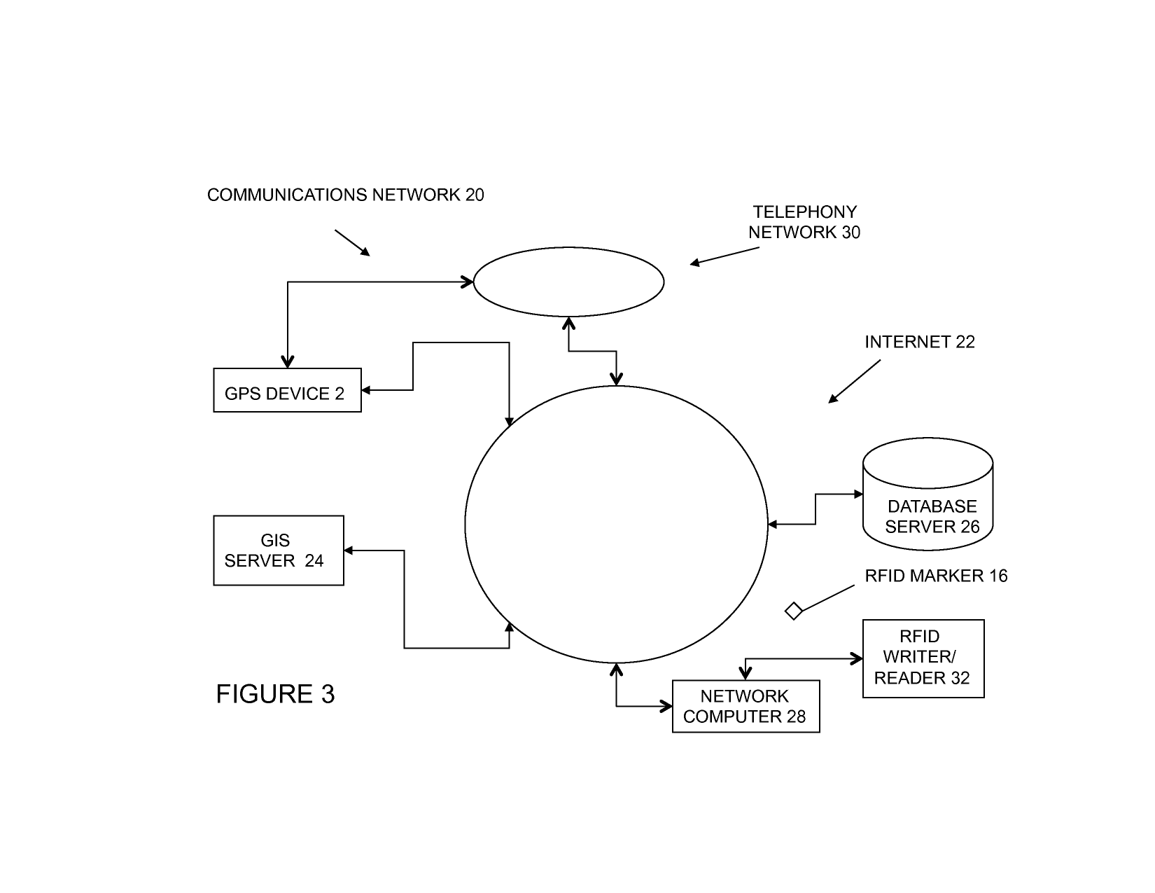

The system software directs the GPS device and the elements 20 through 32 to execute, instantiate and/or comply with the software enabled aspects of the method of the present invention. The input module driver software directs and enables the CPU 2B and the input module 2F in receiving and recording in the system memory data and commands received from the input module 2F, wherein the input module may be a computer keyboard and/or a point and click selection device, or other suitable user input device known in the art. The display module software module SW.3 directs and enables the CPU 2B and the video display module 2G in rendering commands, messages, data and graphics via the video display module 2G. The media reader/writer driver software SW.4 directs and enables the CPU 2B and the media reader/writer in sending and receiving information to and from the media 2N. The network communications software SW.2 directs and enables the CPU 2B and the GPS device 2 in general to bi-directionally communicate with the communications network 20 of FIG. 3.

Referring now generally to the Figures and particularly to FIG. 3, FIG. 3 is a schematic of an electronics communications network 20 comprising the Internet 22, the GPS device 2 of FIGS. 1 and 2, a GIS server 24, a database server 26, and a network computer 28.

The GPS device 2 is communicatively coupled to the Internet 22 and one or more GIS servers 24, database servers 26, and network computers 28 the by means of the network interface module 2J and/or the wireless communications module 2K. An optional intervening telephony network 30 provides an alternate or additional bi-directional communications pathway between one or more GPS devices 2, GIS servers 24, database servers 26, and network computers 28. Information transmitted from the GPS device 2 may be stored at and accessed from the GIS server 24, the database server 26, and/or the network computer 28, whereby a human analyst may examine the information in association with (a.) an identifier of a specific crop cultivation area, e.g., area A, (b.) an identifier of an individual worker 4; (c.) an identifier of a crop area 6; (d.) an identifier of an equipment 12; and/or (e.) an identifier of a crop element harvested from a plant 8.

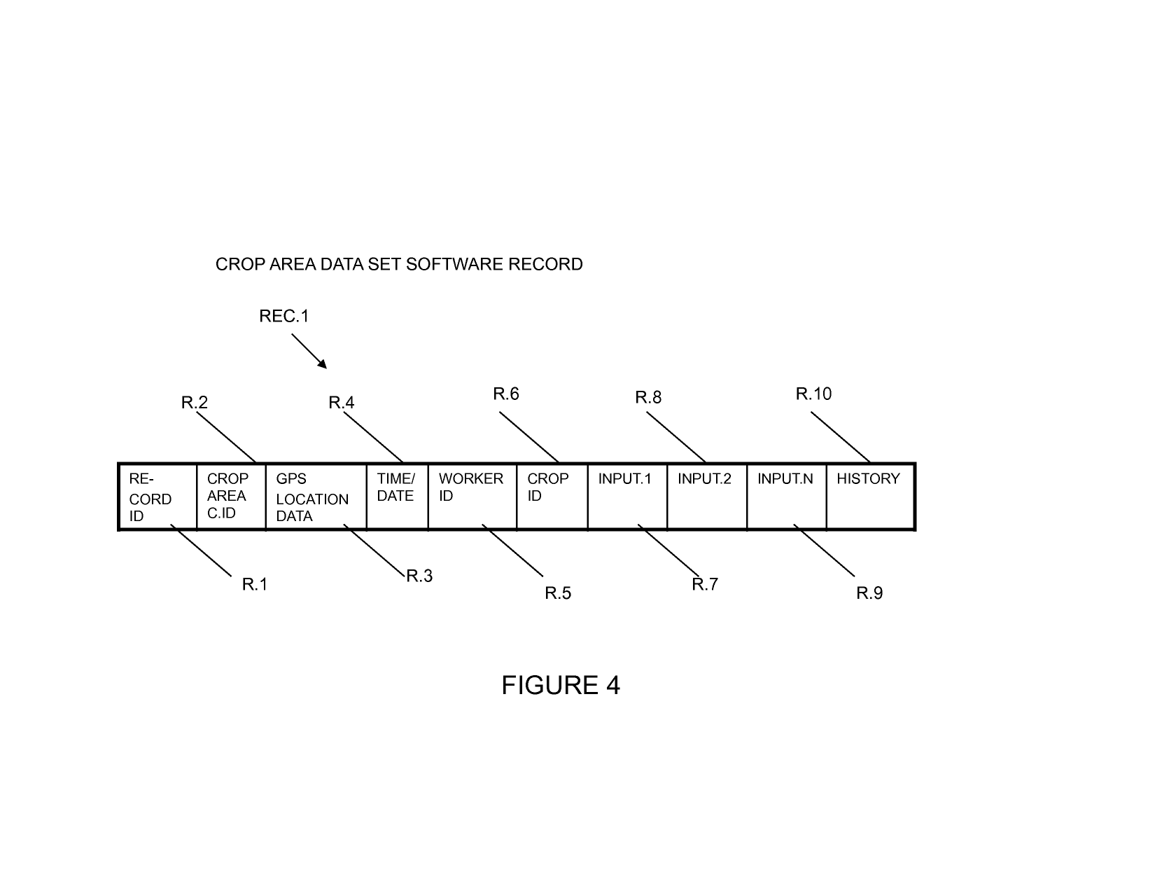

Referring now generally to the Figures and particularly to FIG. 4, FIG. 4 is an illustration of an exemplary crop area data set record REC.1 contained within a database DBS.1-DBS.N. The data set record REC.1 may include a unique record identifier data R.1 relating a crop area identifier A.ID R.2 that identifies s specific crop area 6 (hereinafter “instant crop area” 6″) and associates with Area A, a GPS location data R.3 of one or more associated crop areas 6, one or more time and data stamps R.4 that relate to aspects or information related to the Area A, the instant crop area 6, and/or one or more associated crops 14, one or more worker identifiers R.5, a plurality of data inputs R.7-R.9, that relate to Area A, the instant crop area 14 and/or a specified crop area 6 of Area, and/or historical data R.10 that relate to aspects or information related to one or more associated crops 14, and/or one or more workers 4 identified by a worker identifier R.S. The worker identifier R.5 may be communicated to the GPS device 2 and entered into the first area data set record REC.1 as read by the GPS device 2 via (a.) the GPS device 2 data input device, (b.) radio transmission, (c.) radio signal from a radio frequency identification device 16, and/or (d.) a bar code detection by the bar code reader 2E. The area input entries input.1-input.N R.7-R.9 include data describing the type, time, date, and condition of individual area inputs and other information related to individual and distinguishable area data inputs. The information R.1-R.10 contained within the data set record REC.1 may be received into the GPS device 2 by means of bar code patterns 2O, operator manipulation of the input module 2F, reading from one or more media 2N, and/or from the communications network 20.

One or more data input entries R.7-R.9 my comprise or include a measure of labor hours, an identification of a plant seed, an identification of a plant fertilizing agent, an identification of a plant nutritional agent, an identification of a volume of water, an identification of a pest reduction agent, an identification of a plant disease, and/or other data related to, describing or identifying an agricultural process input. Alternatively or additionally, one or more data input entries R.7-R.9 my comprise or include information that identifies and/or relates to an agricultural process output, such as a fruit or vegetable, a measure of a harvested plant element, an animal or animal product, and/or other agricultural process output known in the art.

Further alternatively or additionally, or more data input entries R.7-R.9 may comprise or include information that identifies and/or relates to a marker of a distinguishable and element of crop output and/or an association of the marker of the element of crop output in tracking the movement in time and space of the element of crop output.

The information each of the crop area record data fields R.1-R.10 of the each crop area records.REC.1-REC.N may be entered into the comprising crop area record REC.1-REC.N by means of manual input into the GPS device 2, the GIS server 24, the database server 26, the network computer 28, or the RFID reader/writer 32 in combination or in singularity.

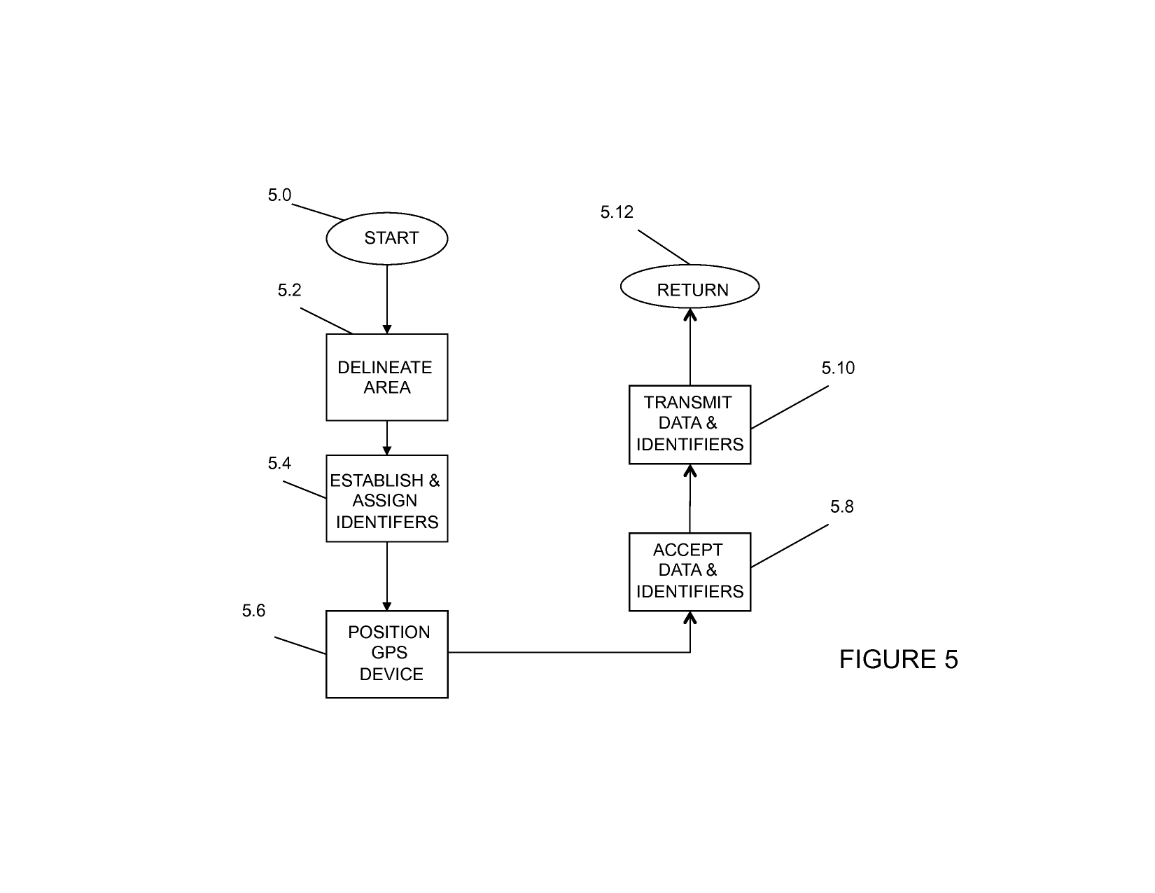

Referring now generally to the Figures and particularly to FIG. 5, FIG. 5 is process diagram of certain aspects of the method of the present invention. In step 5.2 a crop cultivation Area A, the instant crop area 6, and other crop areas 6 are delineated and assigned an identifiers. In step 5.4 identifiers are assigned to one or more crop areas 6, area data inputs R.7-R.9, workers 4, equipment 12, plants 8 and/or animals 10, wherein the instant crop area 6 is identified by a crop area identifier R.2. The GPS device 2 of FIGS. 1, 2 and 3 is positioned in step 5.6 within or proximate to the Area A delineated in step 5.2, and in step 5.8 data and identifiers related to activity in the instant crop area 6 is recorded in the GPS device 2 and optionally formatted in crop area data set software records REC.1-REC.N. The data, identifiers and optionally area data set software records REC.1-REC.N are transmitted from the GPS device 2 via the Internet 22 and/or the telephony network 22 to the GIS server 24 and/or the database server 20.

The GPS device 2, the database server 20, the GIS server 24, and/or the network computer 28 may be a (a.) a network-communications enabled SUN SPARCSERVER™ computer workstation marketed by Sun Microsystems of Santa Clara, Calif. running LINUX™ or UNIX™ operating system; (b.) a network-communications enabled personal computer configured for running WINDOWS XP™, VISTA™ or WINDOWS 7™ operating system marketed by Microsoft Corporation of Redmond, Wash.; (c.) a VAIO FS8900™ notebook computer marketed by Sony Corporation of America, of New York City, N.Y.; (d.) a PowerBook G4™ personal computer as marketed by Apple, Inc. of Cupertino, Calif.; or an IPAD™ tablet computer as marketed by Apple, Inc. of Cupertino, Calif.

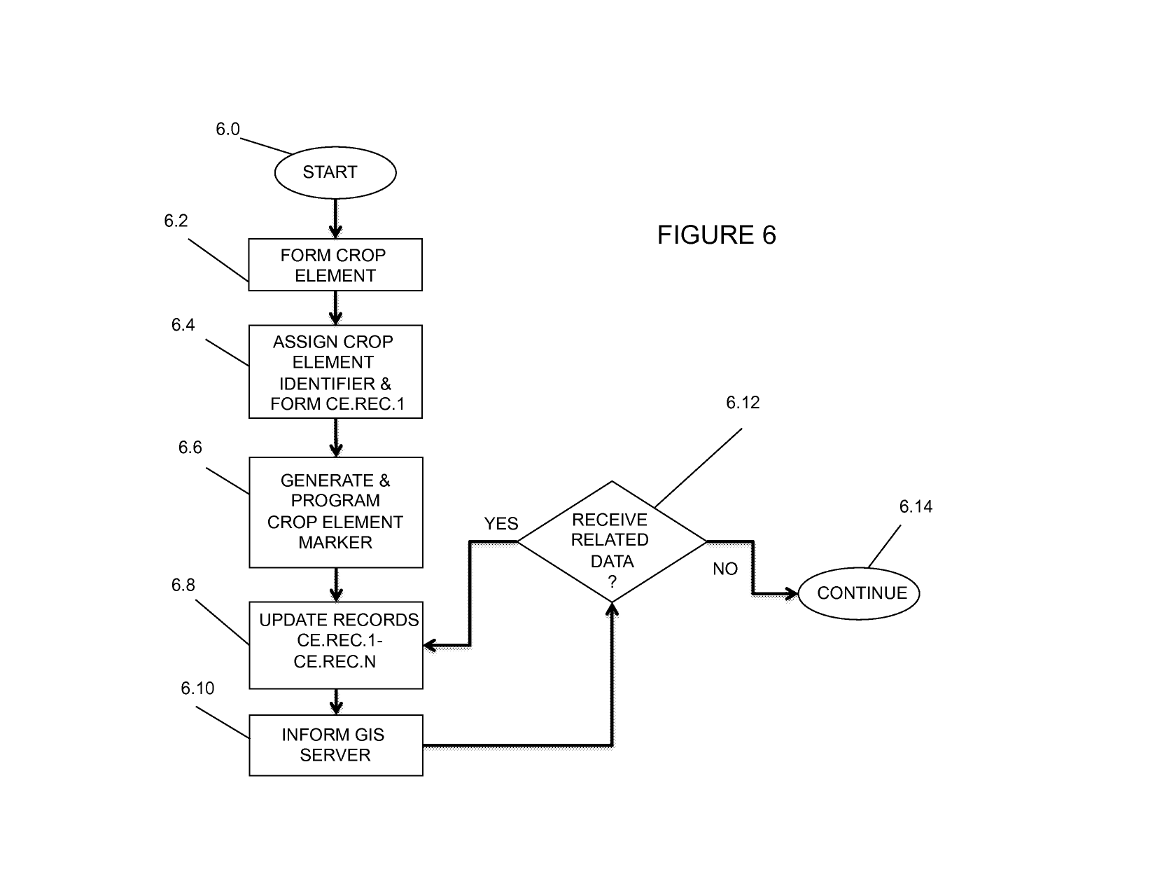

Referring now generally to the Figures and particularly to FIG. 6, FIG. 6 is a flowchart of certain other aspects of the method of the present invention related to monitoring a crop element 14 that may be implemented by the GPS device 2 and the electronics communications network. In step 6.2 a crop element 14 is formed and a crop identifier CE.ID is assigned to the crop element 14 and an exemplary crop element record C.REC. 1 is initiated in step 6.4 and a unique crop element record identifier CE.1 is assigned to the instant exemplary crop element record C.REC.1. A crop element marker, such as an RFID or a bar code pattern 2O is generated and/or marked by printing or programmed in step 6.6 with a crop element identifier CE.ID, and in step 6.8 the crop element record C.REC.1 is updated with identification information CE.ID in the second crop element data field CE.2 of the crop element identifier CE.ID. The GPS device 2 updates the GIS server 24 and/or the database server 26 via the electronics communications network 20 with the information DATA.1-DATA.N received in step 6.8. When the electronics communications network 20 receives in step 6.12 additional information related to the crop element identifier CE.ID or the instant crop area 6, and cycles through step 6.8 and step 6.10 to again update the exemplary crop element record C.REC.1 and/or the GIS device 2 with the information DATA.1-DATA.N received or detected in step 6.12.

One or more crop records CE.REC.1-CE.REC.N may then be stored and updated with information of crop element record data fields CE.1-CE.10, wherein the stored information may be generated by and/or received by and/or stored in whole or in part in the Internet 22 and/or or one or more GPS devices 2, communications networks 20, telephony networks 30, one or more GPS devices 2, GIS servers 24, database servers 26, network computers 28, and RFID writers/readers 32 in combination or in singular.

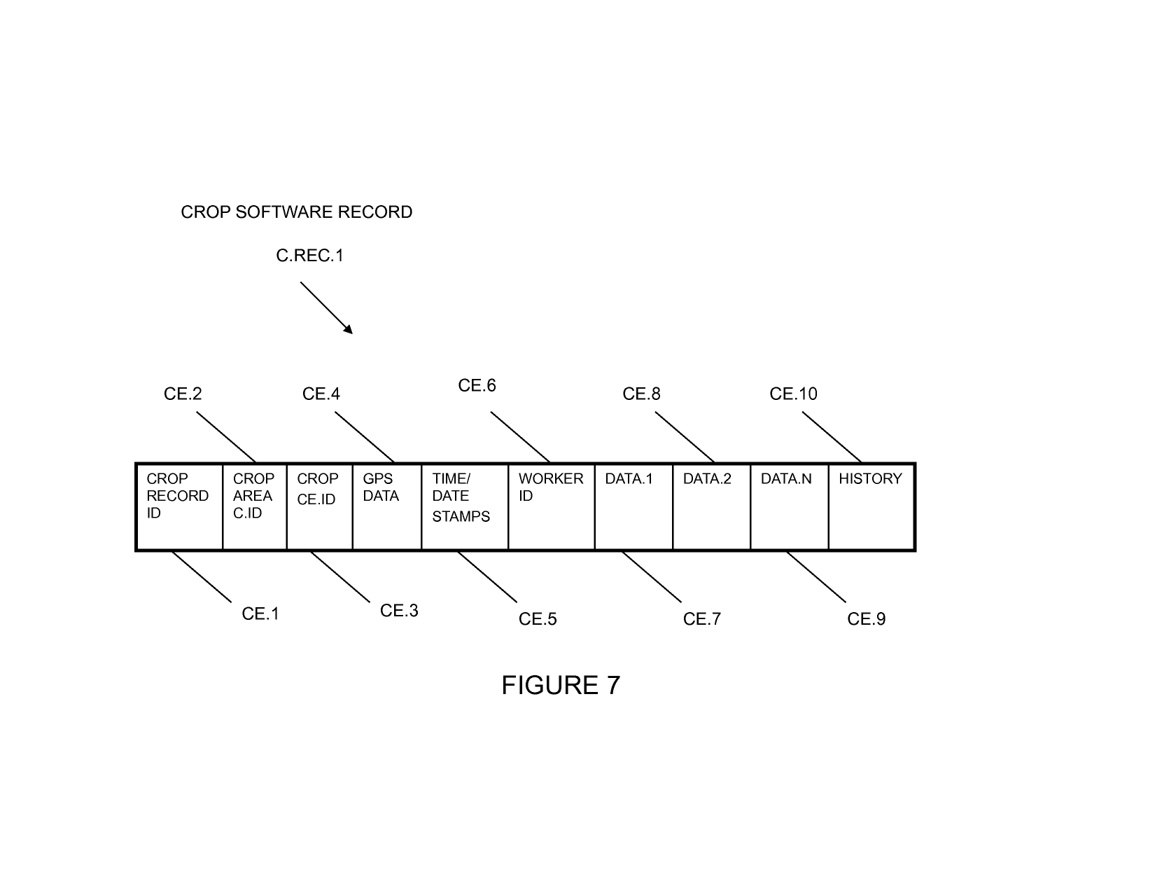

Referring now generally to the Figures and particularly to FIG. 7, FIG. 7 is an illustration of a first crop element record C.REC.1 that includes data relating a first crop element 14 with a originating crop area identifiers CE.ID, the identified crop area 14 being the location from which the crop element 14 was grown, harvested and/or collected and formed. The first crop element record C.REC.1 further comprises a crop element record identifier CE.1, the crop element identifier CE.ID, GPS location data CE.4 optionally related to at least one data DATA.1-DATA.N, time date/stamps CE.5 optionally related to at least one data DATA.1-DATA.N, one or more worker identifiers CE.8 associated with individual workers 4, a plurality of crop data entries DATA.1-DATA.N CE.7-CE.9 related to the first crop element 14 and/or the originating instant crop area 16, and historical data CE.10.

One or more crop data entries DATA.1-DATA.N CE.7- CE.9 and/or the historical data may comprise information relating to the Area A, the associated crop 14, the instant crop area 6, an identification of a plant seed, an identification of a plant fertilizing agent, an identification of a plant nutritional agent, an identification of a volume of water, an identification of a pest reduction agent, an identification of a plant disease, and/or other data related to, describing or identifying an agricultural process input, an agricultural process output comprised within the crop 14 associated with the RFID marker 16, such as a fruit or vegetable, a measure of a harvested plant element, an animal or animal product, and/or other agricultural process output known in the art.

One or more of the plurality of data entries DATA.1-DATA.N may describe the change of condition and/or location of the first crop element 14 as the first crop element 14 is grown or transported from the first area A or exemplary instant crop area band passes through the stream of commerce. The responsibility for the travel time, travel delays and decline in condition of the first crop element 14 may thus be assigned with greater confidence and integrity by reference to the information contained within the first crop element record C.REC.1 or elsewhere in a database DBS.1-DBS.N of the GPS device 2, and one or more GIS servers 24, database servers 26, and/or network computers 28.

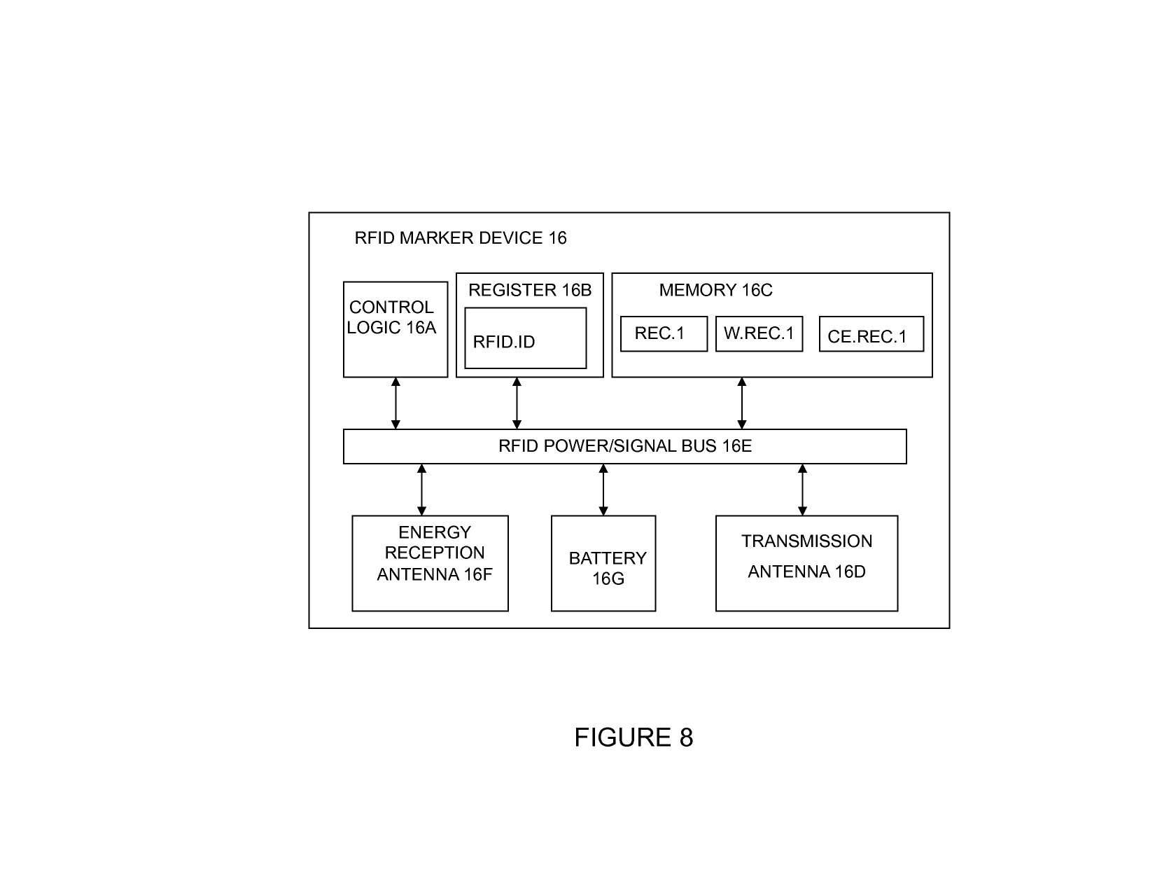

FIG. 8 is a schematic of the RFID device 16 containing a crop element identifier CE.ID of FIG. 7. A control logic 16A, a register 16B, optional memory 16C, and transmission antenna 16D are communicatively coupled with an RFID power and signal bus 16E. Electrical energy received by an energy reception antenna 16F is transferred to a battery 16D via the RFID power and signal bus 16E. Electrical power is additionally provided via the RFID power and signal bus from the battery 16G to the control logic 16A, register 16B and memory 16C. The register 16B stores the crop element identifier CE.ID and optionally the memory stores one or more crop area records C.REC.1-C.REC.N.

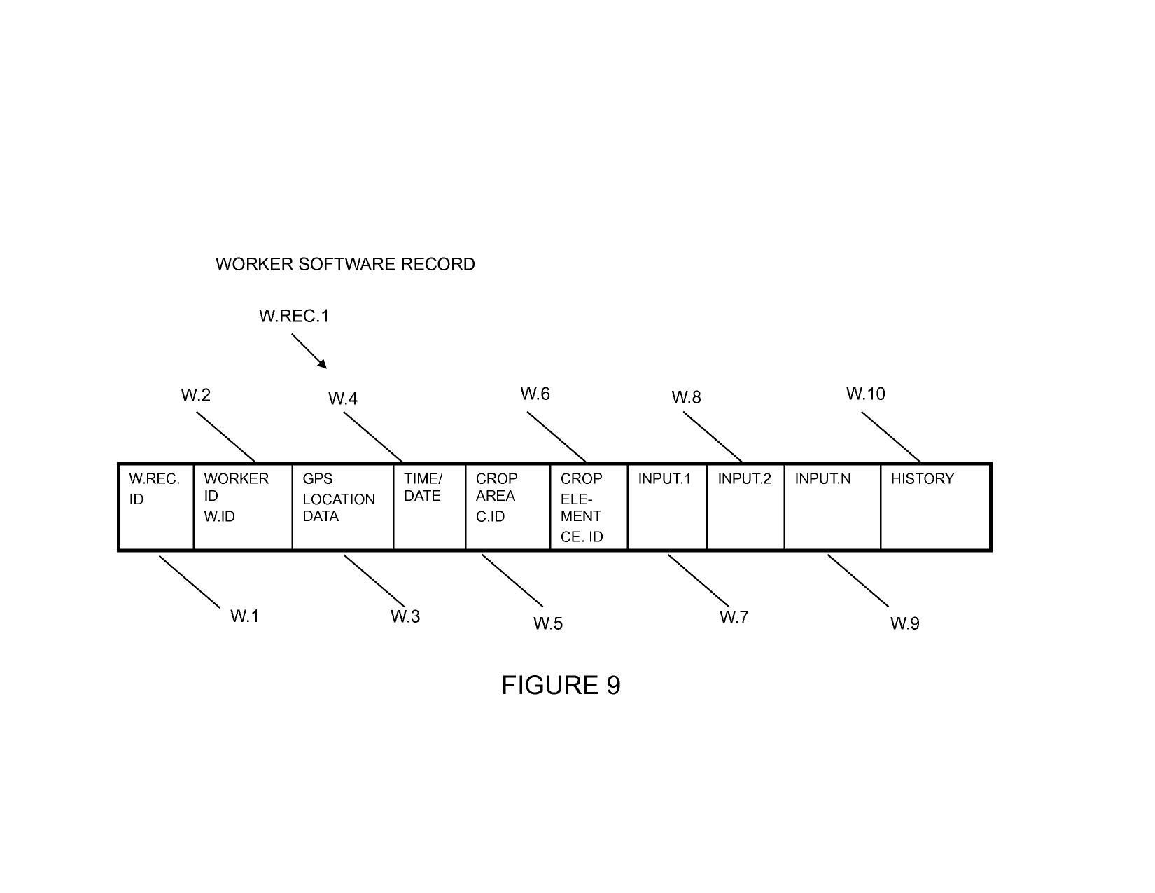

FIG. 9 is an illustration of an exemplary first worker record W.REC.1 that includes a worker identifier W.ID and information INPUT.1-INPUT.N related to a particular and exemplary worker 4 associated with the worker identifier W.ID. The Worker identifier W.ID may be, comprise, or be associable with a government issued immigration service identifier and/or tax identifier, such as a social security account number. issued and crop area(s) and crop element(s) of FIGS. 1, 4 and 7. The information for each of the worker record data fields W.1-W.10 of the each worker record W.REC.1-W.REC.N may be entered into the comprising worker record W.REC.1-W.REC.N by means of manual input into the GPS device 2, the GIS server 24, the database server 26, the network computer 28, or the RFID reader/writer 32 in combination or in singular.

The process of FIG. 6 may be applied to generate and update a worker record wherein an individual worker 4 is identified in step 6.2. A worker record identifier R.1 is assigned or received and an exemplary first worker record W.REC.1 is formed in step 6.4. The first worker record W.REC.1 is then instantiated in step 6.6 and the worker record identifier W.ID of step 6.4 and a worker identifier W.ID associated with the worker 4 selected in step 6.2 is written into the exemplary first worker record W.REC.1.

One or more worker records W.REC.1-W.REC.N may then be stored and updated with information of worker record data fields W.1-W.10, wherein the information may be generated by and/or received by and/or stored in whole or in part in the Internet 22 and/or or one or more GPS devices 2, communications networks 20, telephony networks 30, one or more GPS devices 2, GIS servers 24, database servers 26, network computers 28, and RFID writers/readers 32 in combination or in singularity. A bar code record 2O may further be generated to store and display patterned information that identifies and/or is related to the worker 4 identified by the worker identifier W.ID.

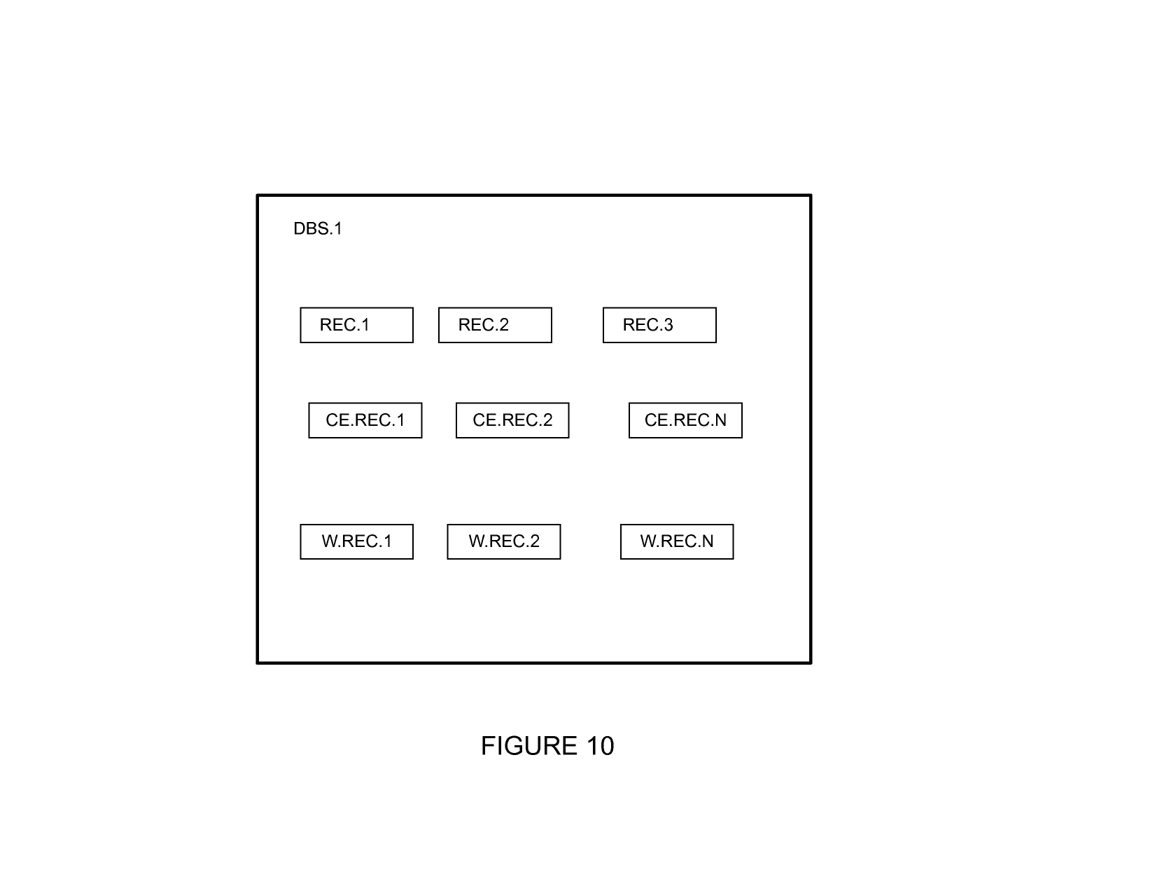

FIG. 10 is an illustration of the exemplary database DBS.1 of FIG. 2 that may be stored in the GPS device 2, computer or server of FIG. 1, 2, or 3 and comprising information partially or entirely of records REC.1-REC.N, CE.REC.1- CE.N &W.REC.1-W.REC.N of FIGS. 2, 4, 7 and 9.

The foregoing disclosures and statements are illustrative only of the present invention, and are not intended to limit or define the scope of the present invention. The above description is intended to be illustrative, and not restrictive. Although the examples given include many specificities, they are intended as illustrative of only certain possible applications of the present invention. The examples given should only be interpreted as illustrations of some of the applications of the present invention, and the full scope of the Present Invention should be determined by the appended claims and their legal equivalents. Those skilled in the art will appreciate that various adaptations and modifications of the just-described applications can be configured without departing from the scope and spirit of the present invention. Therefore, it is to be understood that the present invention may be practiced other than as specifically described herein. The scope of the present invention as disclosed and claimed should, therefore, be determined with reference to the knowledge of one skilled in the art and in light of the disclosures presented above.

I claim:

1. A method for managing an agricultural workflow, the method comprising:
a. defining a unique area of agricultural production;
b. recording inputs to the area with a geolocational confirmation device;
c. reporting the inputs and related geolocation confirmations to a database in association with the unique area;
d. recording outputs from the area with the geolocational confirmation device; and
e. reporting the outputs and related geolocation confirmations to a database in association with the area, whereby a net yield of the unique area over a time period can be appraised in view of the inputs and outputs of the area.

2. The method of claim 1, wherein at least one input is a worker identifier.

3. The method of claim 1, wherein at least one input is a measure of labor hours.

4. The method of claim 1, wherein at least one input is a plant seed.

5. The method of claim 1, wherein at least one input is a plant fertilizing agent.

6. The method of claim 1, wherein at least one input is a plant nutritional agent.

7. The method of claim 1, wherein at least one input is a volume of water.

8. The method of claim 1, wherein at least one input is a pest reduction agent.

9. The method of claim 1, wherein at least one input is a plant disease inhibition agent.

10. The method of claim 1, wherein at least one output is a fruit or vegetable. Identifier.

11. The method of claim 1, wherein at least one output is a measure of a harvested plant element.

12. A system for managing an agricultural workflow, the system comprising:
a) an input device for receiving user commands, worker identification signals, and geolocational data;
b) a processor unit communicating with the input device to designate input from the input device to a unique area and for processing the user commands, worker identification signals, and geolocational data;
c) a memory for storing the user commands, worker identification signals, and geolocational data; and
d) an output device for displaying information received from the input device.

13. The system of claim 12, further comprising a marker of an element of crop output.

14. The system of claim 12, further comprising an association of the marker of the element of crop output in tracking the movement in time and space of the element of crop output.

15. The system of claim 12, wherein at least one worker identification signal is associated with an individual worker and documents the physical presence of the worker.

16. The system of claim 15, wherein at least one user command documents a measure of work attributed to an individual worker.

17. The system of claim 12, wherein the input device and the processor are communicatively coupled by a wireless communications link.

18. The system of claim 12, wherein the input device and the processor are communicatively coupled by an electronic communications network.

19. A device for managing an agricultural workflow, the device communicatively coupled with an electronic communications network and comprising:
a) an input module for receiving user commands, worker identification signals, and geolocational data;
b) a processor module coupled with the input module for processing the user commands, worker identification signals, and geolocational data, and for assigning markers to elements of crop output;
c) a memory element coupled with the processor for storing the user commands, worker identification signals, geolocational data, and crop output markers;
d) an output module for displaying information received by the input device and for displaying computational results generated by the processor module; and
e) a wireless communications module communicatively coupled with electronic communications network for receiving commands and data from the electronic communications network and for transmitting user commands, worker identification signals, geolocational data, and crop output markers to the electronic communications network.

20. The device of claim 17, wherein the device is associated with a unique crop area by a server of the electronic communications network.
